(19) United States
(12) Patent Application Publication
(10) Pub. No.: US 2006/0291339 A1
(43) Pub. Date: Dec. 28, 2006

(54) Thickness variation correction on a disc

(76) Inventor: Andrei Mijirtiskii, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/573,558

(22) PCT Filed: Sep. 16, 2004
(86) PCT No.: PCT/IB04/03118

§ 371 Date: Mar. 27, 2006

(30) Foreign Application Priority Data
Sep. 30, 2003 (EP) 03300136.3

(51) Int. Cl. G11B 7/24; G11B 3/70

(52) U.S. Cl. 369/30.24; 369/275.3; 369/283

(57) ABSTRACT

An optical storage carrier is provided with an entrance face, and information layer and a transparent layer between the entrance face and the information layer. The information layer holds a relief structure representative of readable data that may be read through the transparent layer by focusing of radiation beam. The carrier also includes a read-only zone such as the conventional lead-in zone where informative data is stored indicating at least one radius where a thickness variation of the transparent layer potentially occurs. When inserted in a scanning device, a measurement is carried out of the thickness of the transparent layer at the indicated radius and appropriate spherical aberration correction can be derived and the focus of the light beam on the information layer is adjusted.

The present invention relates to the optical recording field and more particularly to optical recording media and players based on one of the numerous international optical recording standards.

Optical recording media fall into several categories, including read-only (readable, but not writeable), recordable (writeable one time only) and re-writeable (write, erasable and re-writable) type of carriers. When the optical record carrier is an optical disc, each of the aforementioned types of optical record carrier undergoes a pre-forming manufacturing process that creates at least one track on the disc. For each disc category, data may be placed onto the one or more tracks and the way data is so placed varies according to the disc category.

For example, read-only optical discs are reproduced from a master copy by a well-known manufacturing process known as stamping. The one or more data tracks include a pit train comprising a plurality of pits (or indentation), which are spaced irregularly on the disc layer. The length of pits and lands (disc portion between the pits) contains analog data and forms a relief of data on the information layer of the disc.

For recordable carriers, the one or more tracks are coated with a recordable layer composed of an organic dye. Data may be written to the recordable information layer by physically burning the organic dye with a radiation source, typically a laser, thereby creating marks therein.

For re-writable record carriers, the one or more tracks are coated with a thin film layer stack, comprising at least one recording layer, a reflective layer and generally one or more dielectric layer. The recording layer comprises a compound made up of a plurality of materials, which are capable of existing in a plurality of different states (crystalline or amorphous), depending on the level of radiation applied thereto. Since crystalline and amorphous areas have a different reflectivity level, and reversible transitions between the amorphous and crystalline states are possible by applying laser power at various levels, writing and erasing of data is possible.

Recordable and re-writable discs can also include a relief structure that holds read-only data; such regions typically include the lead-in zone and contain control data and/or informative data.

In conventional optical disc formats, like Magneto-Optical (MO) disc formats, compact disc (CD) and Digital Versatile Disc (DVD), the transparent layer is generally made by injection moulding the substrate and the disc is read-out through the substrate. In other types of discs, such as the Blu-ray™ disc the transparent read-out layer is either formed by bonding a thin polycarbonate foil onto the substrate, or by a “spin coating” process, which involves applying lacquer to the surface of the information layer and rotating the disc. Centrifugal forces associated with rotation of the disc cause the lacquer to be distributed over the surface of the information layer, forming the transparent layer.

A common issue with techniques such as spin coating is that there can be significant variations in the thickness of the transparent layer, in particular in the radial direction of the disc. As is well known in the art, the performance of an optical scanning device is sensitive to the presence of spherical aberrations in the laser spot that is focused on the information layer of the disc. Spherical aberrations arise in the spot when thickness variation occurring between layers of the disc is not compensated. Thus if the thickness of the transparent layer falls outside of predetermined limits, due to an unexpectedly thick or thin region of the transparent layer, the distance to the information layer may correspondingly be less than or exceed that for which the optical scanning device is designed. This can result in an increase in spherical aberrations in the focused radiation source, and a deterioration of data signals and malfunctioning of the detection system used to detect signals encoded on the optical disc.

Several empirical methods have been developed for detecting thickness variation and compensating for spherical aberrations introduced by the radiation passing through a transparent layer of varying thickness. Some of these methods are described below.

US2002/0054554 describes a method whereby a test region of the optical disc is scanned, whilst the amplitude of the playback signal is measured. This test region comprises at least first and second pit trains, and the period of the first pit train differs from that of the second pit train. Due to the differences in periods, the amplitude of a playback signal corresponding to the first pit train differs from that of the playback signal corresponding to the second pit train. If the thickness of the transparent layer is uniform across the radius of the disc, the point at which the amplitude signals are focused, i.e. the point of maximum amplitude, can be expected to be the same for the two pit trains. However, if the thickness of the transparent layer varies across the radius of the disc, the point at which the maximum signal corresponding to the first pit train occurs differs from the point at which the maximum signal corresponding to the second pit train occurs. Thus the difference between the points at which the maximum signal amplitude corresponding to the respective pit trains occurs can be used to identify a thickness variation. In this solution, the test regions have to be analyzed for each disc whenever introduced into a player or scanning device, and thickness data for regions outside the test regions have to be assumed or interpolated. If a plurality of test regions need to be analyzed, the described process might be time consuming. Furthermore, the test regions take up space on the disc which could otherwise provide useful data capacity.

U.S. Pat. No. 6,381,208, incorporated herein by reference, describes a method whereby data relating to thickness and refractive index of the transparent layer is measured after the disc is manufactured. This thickness data is thereafter written on the optical disc, on a writable portion of the information layer. When an optical scanning device scans the disc, the thickness data is read and is used to modify the position of lenses thereof, effectively compensating for spherical aberrations associated with the thickness variations. The data is stored in the form of average thickness and unevenness in thickness at various distances along the radius of the disc, and the optical scanning device is arranged to access a look-up table detailing lens configuration as a function of thickness. Thus, once the scanning device has read in the thickness and refractive index information stored on the disc, lens configuration data corresponding thereto can be retrieved from the look-up table.

Reference is also made to European Application 02080326.8 (Attorney docket number NL021422), of the same assignee, incorporated herein by reference. This document proposes to include a relief structure in the read-only zone of the disc that is representative of the thickness variation of the transparent layer. The relief structure may be added to the disc during the stamping process when the disc is initially manufactured or reproduced. This proposed solution is based on the premises that coarse variations in thickness of the transparent layer can be known in advance for well-defined manufacturing processes and that the thickness profile of the disc will not vary tremendously from one disc to another coming out of the same manufacturing process.

The three solutions detailed hereinabove each presents disadvantages that need to be overcome. For example, the second solution results in a manufacturing overhead since the thickness profile has to be measured per disc and written into each disc. In the third solution, numerous measurements may implicitly be required for different radii before a reliable set of data can be obtained.

The inventors have thus sought an alternative solution that alleviates these disadvantages without adding complex measurements or extra manufacturing steps.

An optical record carrier is therefore proposed that includes an entrance surface and an information layer including a relief structure representative of readable data. The carrier also includes a transparent layer located between the entrance layer and the information layer through which the data may be read from the information layer. The carrier further includes a lead-in zone including informative data indicating at least one radius where thickness variations of the transparent layer potentially occur.

The inventors have realized that this solution permits to ameliorate the aberration correction at the time of playing the disc based on the informative data read from the lead-in zone. The indicative data is for example inscribed on the carrier by a disc replicator at the manufacturing stage. When the carrier is inserted in a scanning device, the radius is extracted from the informative data and subsequent tests for measuring the thickness variation can be performed at this radial position. The scanning device into which the carrier is inserted may focus its thickness variations measurements only at the one or more radius indicated by the informative data and interpolates or extrapolates thickness variations for other radii based on the measurements results. An advantage of one or more embodiments of the invention is the simplicity and the precision of the proposed ways of detecting the thickness variation.

These and other aspects of the invention will be apparent from and will be elucidated with reference to the embodiments described hereinafter.

The present invention will now be described in more detail, by way of examples, with reference to the accompanying drawings, wherein:

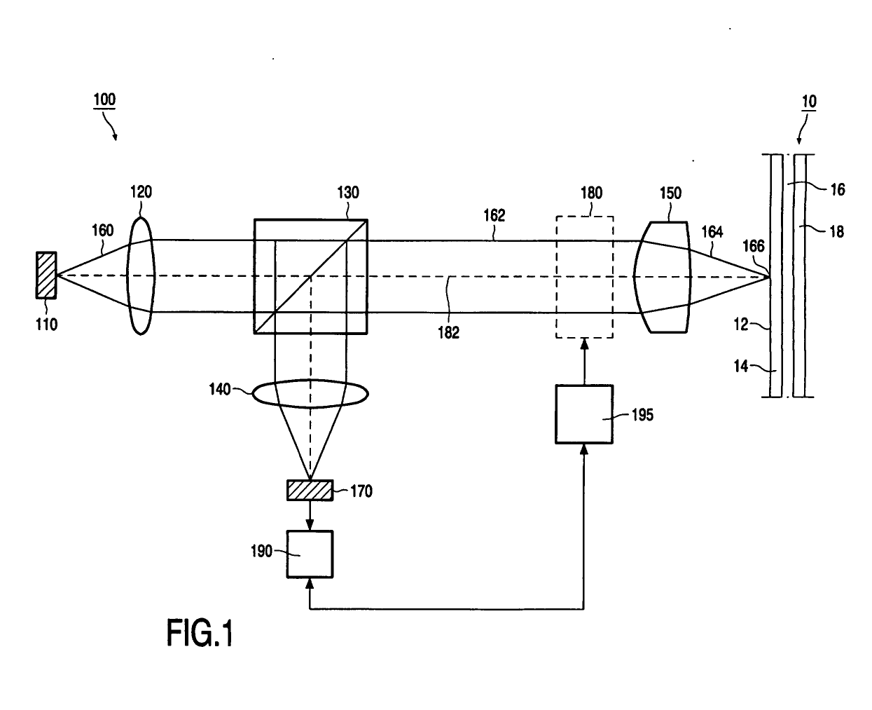

FIG. 1 is a schematic diagram of an optical scanning device operating in conjunction with a record carrier of the invention

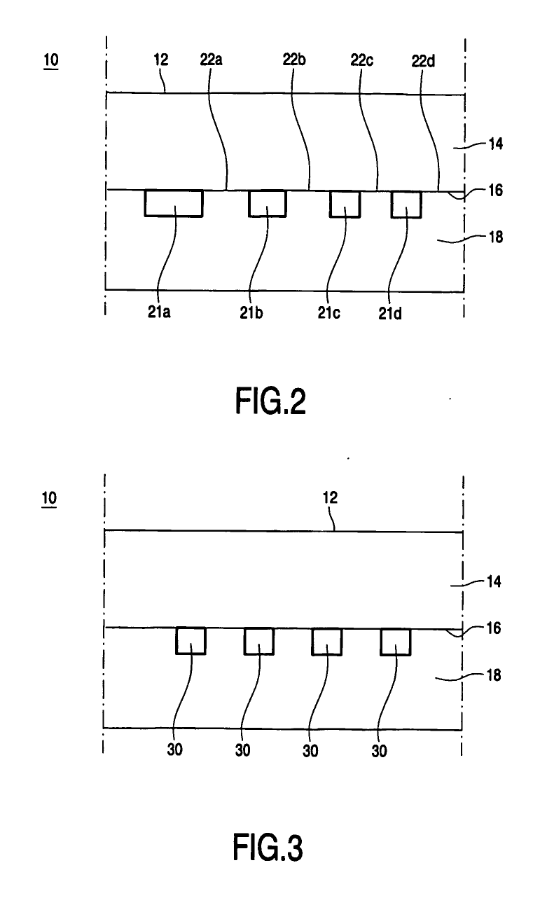

FIG. 2 is a schematic cross section along a data track in a lead-in zone of an optical disc;

FIG. 3 is another schematic cross section along a data track in a lead-in zone of an optical disc;

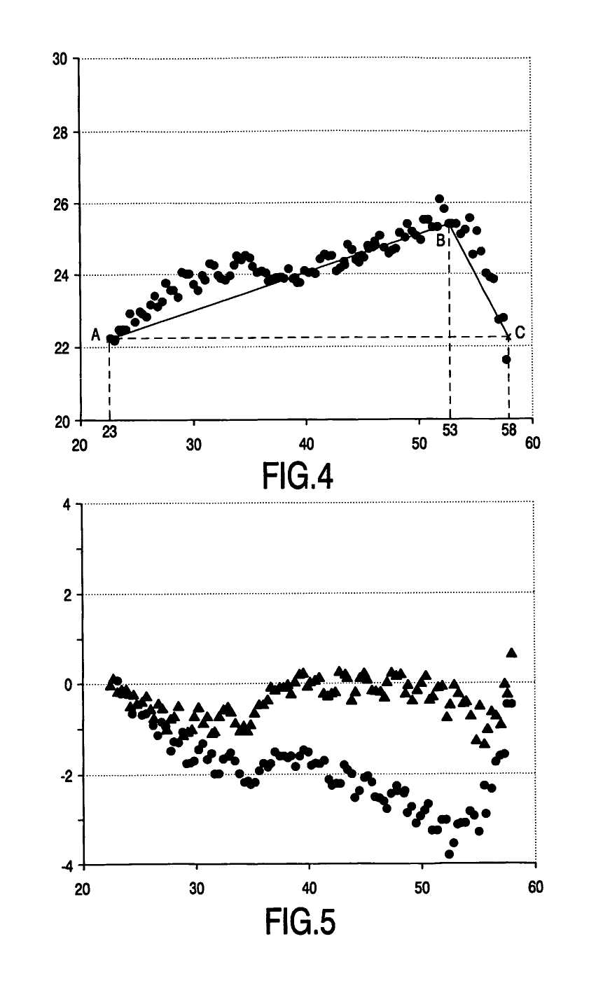

FIG. 4 is diagram showing a graphical representation of a radial thickness profile of the transparent layer.

FIG. 5 is a diagram showing deviations of the estimated thickness profile of the transparent layer vs. the reality for an optical record carrier of the invention.

Elements within the drawings having similar or corresponding features are identified by like reference numerals.

FIG. 1 shows a schematic diagram of an optical scanning device 100 with which optical disc 10 is arranged to operate. Otical scanning device 100 includes a radiation source 110, for example a semi-conductor laser, emitting a diverging radiation beam 160. A beam splitter 130, for example a semi-transparent plate, is arranged to transmit the diverging beam 160 towards a lens system. The lens system includes a collimator lens 120 and an objective lens 150 arranged along an optical axis 182.

Collimator lens 120 is arranged to transform the diverging beam 160 emitted from radiation source 110 into a substantially collimated beam 162. Objective lens 150 is arranged to transform incident collimated beam 162 into a converging beam 164, having a selected numerical aperture (NA), which comes to a spot 166 on a layer of optical disc 10 (specifically information layer 16, described in more details below). A detection system 170 and a second collimator lens 140, together with beam splitter 130, are provided to detect a main information signal, focus and track spot 166 to ultimately generate error signals, which are used to mechanically adjust the axial and radial positions of objective lens 150.

Optical system 100 also includes a spherical aberration compensator 180, which is operated by a compensation signal generator 182. Compensator 180 may take any of a number of different forms, for example a variable focus liquid crystal lens. Alternatively, compensator 180 may be arranged to adjust the spacing between two lenses of a compound objective lens 150, or to adjust the spacing between collimator lens 120 and radiation source 110.

Optical disc 10 comprises a transparent layer 14, on one side of which at least one information layer 16 is arranged, and further comprises entrance face 12 on its other side. Information layer 16 includes a reflective layer (not shown). The side of information layer 16 facing away from transparent layer 14 is protected from environmental influences by a protection layer 18. Transparent layer 14 acts as a substrate for the optical disc 10 by providing mechanical support for information layer 16 and/or reflective layer. Alternately, transparent layer 14 may have the sole function of protecting information layer 16, which, in case of a multi-layer optical disc, is the uppermost information layer, while mechanical support is provided by a layer on the other side of information layer 16, for instance by protection layer 18 or by a further information layer and transparent layer connected to the uppermost information layer. In case of a multi-layer optical disc, two or more information layers are arranged behind a first transparent layer, and an information layer is separated from another information layer by a further transparent layer. Each information layer is located at a different depth within the disc with respect to entrance face 12.

Transparent layer 14 essentially presents a refractive medium for converging beam 164 to pass through. As stated above, a problem with the spin coating process used to create transparent layer 14 is that there can be significant variations in the thickness of transparent layer 14, such that the distance between information layer 16 and entrance face 12 varies across disc 10. If the thickness of layer 14 is non-uniform in the radial direction, the degree of spherical aberration in spot 166 at various points along the radius will vary. As a result both data and control signals can be expected to be poor at certain radial locations.

FIG. 2 shows a cross-section through part of a data track in the lead-in zone of optical disc 10. The lead-in zone includes control data for initializing scanning device 100 when disc 10 is inserted into it, and is located at the innermost periphery of the readable portion of disc 10. Disc 10 includes a relief structure in the form of a series of pits 21a, 21b, 21c, 21d of various lengths and spacings alternately interposed in a series of lands 22a, 22b, 22c, 22d along the data track. The relief structure holding data is formed by a stamping injection molding process from a master having corresponding pattern on its face.

FIG. 3 illustrates an alternative format of lead-in zone, used in a different embodiment of disc 10, which is shown in radial section in this Figure. The lead-in zone includes a relief structure in the form of land/groove structure. Each groove 31 may form a spiral or circular track. Data is held in the land/groove structure in the form of a high frequency modulated wobble pattern, whereby the groove alternately meanders slightly to each side from its overall path in accordance with read-only data held in the wobble pattern. Again, the relief structure holding the data is formed by a master having a corresponding pattern on its face.

In the following, it is assumed that disc 10 is of the read-only format but the invention also encompasses recordable and rewritable optical storage carriers for which the lead-in zone has at least a read-only portion.

The lead-in zone of disc 10 includes informative data that indicates at least one radius value where thickness variation is likely to occur. Informative data may include the actual radius value in an absolute or relative form or may comprise, for example, a pointer to the radial position where tests can be performed. Scanning device 100 runs tests and measurements of thickness of transparent layer 14 based on the informative data as is explained as follows. The informative data may be characterized at the time of manufacture by the disc replicator and may be determined based on the characteristics of disc 10 only and/or other discs manufactured using the same manufacturing process. For a given manufacturing process, measurements may be regularly done on the produced discs at different radii and a disc radius for which the measured thickness is not comprised within an acceptable range of thickness variations may be appropriately flagged. All discs or optical storage carriers produced by the same manufacturing process may carry the same informative data or alternately, the informative data may be adapted over time to take into account variations in the different manufacturing stages such as spin coating, materials used, room temperature and the like. For example if it can be observed that the thickness of the transparent layer coarsely and repeatedly varies at a specific radius value of discs manufactured according to the same process, this value may be automatically included in the informative data of these discs. Alternatively, the manufacturing process may be referred to in the informative data and a scanning device having access to the informative data is configured to retrieve characteristics associated with the manufacturing process, such as the radii values for which thickness variations potentially occur.

It must be noted that the invention encompasses writing at least one radius value only or at least information leading to the retrieval of this radius value, e.g. a manufacturing process identification number or a pointer. The invention does not comprise including the thickness variation occurring at the indicated radius at the time of manufacture, although the actual thickness, or an approximation of it, may be ultimately written onto disc 10 after scanning and measurement by scanning device 100.

In another exemplary embodiment, informative data may further include a severity indicator representative of a level of coarseness of the thickness variation that potentially occurs at an associated radius value. For example, if a manufacture process is known to cause a recurrent deviation at a given radial position for all discs produced, the radial position will be flagged as severe in the lead-in zone. The severity indicator may help to determine whether scanning device 100 shall try to correct the spherical aberration or whether a jump-ahead instruction should be issued, e.g. after a first unsuccessful correction attempt.

When disc 10 is inserted in scanning device 100, control unit 190 extracts the at least one radius value from the informative data. Control unit 190 may instruct detection system 170 of scanning device 100 to access and read lead-in zone of disc 10. Control unit 170 then controls a measurement of thickness of transparent layer 14 at the indicated radial position. Based on the measured thickness, correction unit 195 controls the derivation of an optimum correction of the spherical aberration occurring at the radius value. In the case of read-only disc, the optimum correction may be determined by reading data at the radius value with a variety of spherical aberration compensation settings whilst detecting a jitter value in the main information signal, and optimizing the settings to a minimum jitter value. For optical discs, data may be written into the disc at the indicated radius value using a standard spherical aberration compensation settings to begin with, followed with an optimization of the spherical aberration compensation settings whilst reading the data back. Once an optimum compensation settings is found, the data may be re-written using the optimum settings obtained for the read-out of data, and the optimization may be carried out repeatedly using the newly re-written data.

The hereinabove described compensation methods are only given here as illustrative purposes and should not be used to limit the scope of the invention. The invention is by no way limited to a specific approach to compensate for the spherical aberration and any method can be used without departing from the scope of the invention.

In yet another exemplary embodiment, a multi-layer optical disc, comprising at least first and second information layers and corresponding first and second transparent layers is provided. Each transparent layer has been applied on top of the respective associated information layer by spin coating and may have corresponding thickness variation profiles. The profiles of the two transparent layers may differ or may be similar. Thus, one or more read-only portions of the disc include radii values of the invention. Radii values may be different for both transparent layers.

FIG. 4 and FIG. 5 represent examples of thickness variation profile for disc 10. FIG. 4 shows the thickness in μm versus the disc radius in mm. FIG. 5 shows the deviation from the estimated thickness for different disc radii. As can be seen on the diagram of FIG. 4, the actual thickness of transparent layer 14—indicated by dots—varies significantly with the radius value. If scanning device 100 were to apply a simple spherical aberration, scanning device 100 would typically measure the thickness variation at two instances: at an inner radial position of disc 10 and on an outer periphery of disc 10. Scanning device 100 may then extrapolate thickness of transparent layer 14 from these two values and may then assume a constant thickness of transparent layer 14 across disc 10 represented on FIG. 4 by a dashed line. As shown in FIG. 4, such assumption greatly differs from the actual thickness variation across disc 10 represented by dots in FIG. 4. For example, at the radius 53 mm, a thickness of 22 μm is predicted when the actual thickness is 26 μm. In the invention, informative data stored in lead-in zone of disc 10 of which profile is such as shown in FIG. 4, indicates radii 23, 53 and 58 mm where tests should be performed. Scanning device 100 when reading disc 10 measures respective thicknesses of transparent layer 14 at radii 23, 53 and 58 mm and interpolates respective thickness values for other radii within the range [23; 58]. In this embodiment, thickness profile 400 across disc 10 is determined from linear extrapolation based on the three measured thicknesses referenced by points A, B and C.

FIG. 5 shows respective deviations of the thickness profile for the two methods described above. The dots represent the deviation of the predicted thickness vs the actual thickness if thicknesses are considered at only two radii (at the two extremes) and the triangles represent the deviation of the predicted thickness profile according to the invention vs. the actual thickness profile. As it can be seen, an additional measurement of the thickness performed at radius 43 mm as indicated in the informative data permits to obtain a relatively better approximation of the thickness variation of the transparent layer 14 across surface of disc 10.

In the above description, and in the accompanying claims, the term “relief structure” has been used to describe a structure in, or following, a surface having height variations. Such height variations can also be referred to in the art as embossments and occur due to corresponding height variations in a master used during a stamping procedure. Such a relief structure may include a pit/land train, a wobble pattern in a groove, a combination of the like, and/or other features provided by height variations stamped onto a surface.

It is to be understood that any feature described in relation to any one embodiment may be used alone, or in combination with other features described, and may also be used in combination of any other of the embodiments. Furthermore, equivalents and modifications not described above may also be employed without departing from the scope of the invention, which is defined in the accompanying claims.

1. An optical storage carrier for use in an optical scanning device, the carrier comprising:
an entrance surface;
an information layer including a relief structure representative of readable data;
a transparent layer located between the entrance layer and the information layer through which the data is read from the information layer; and,
a lead-in zone including informative data indicating at least one radius where a thickness variation of the transparent layer potentially occurs.

2. The optical storage carrier of claim 1, wherein the informative data is permanent.

3. The optical storage carrier of claim 1, wherein the informative data comprises the radius.

4. The optical storage carrier of claim 1, wherein the informative data comprises a pointer to the radius.

5. The optical storage carrier of claim 1, wherein the informative data further comprises a severity indicator representative of a coarseness of the thickness variation potentially occurring at the radius.

6. The optical storage carrier of claim 1, wherein the informative data is inscribed in the lead-in zone during manufacturing of the carrier.

7. The optical storage carrier of claim 1, wherein the radius is deducted from tests performed on carriers manufactured by a same manufacturing process as the carrier.

8. A device comprising:
a receptacle for receiving an optical storage carrier comprising an entrance layer, an information layer including a relief structure representative of readable data and a transparent layer located between the entrance layer and the information layer through which the data is read from the information layer and a lead-in zone;
a radiation beam arrangement for focusing a light beam on the information layer through the transparent layer;
a measurement unit for measuring the thickness of the transparent layer at the radius indicated in the informative data;
a servo for adjusting a focus of the light beam on the information layer at the radius based on the measured thickness.

9. The device of claim 8, wherein the measurement unit is adapted to derive respective thicknesses for other radii by interpolation or extrapolation based on the measured thickness.

10. The device of claim 8, wherein the servo adjusts the focus at a respective radii based on the respective derived thickness.

11. The device of claim 8, wherein the measurement unit is adapted to perform another measurement of the thickness of the transparent layer at another radius.

12. A method for detecting a thickness variation on an optical storage carrier, the method comprises:
enabling receiving the optical storage carrier comprising an entrance layer, an information layer including a relief structure representative of readable data and a transparent layer located between the entrance layer and the information layer through which the data is read from the information layer;
enabling accessing informative data stored in a lead-in zone of the optical storage carrier, the informative data indicating a radius on the carrier where a variation of a thickness of the transparent layer potentially occurs;
performing a measurement of the thickness variation of the transparent layer at the indicated radius; and,
correcting a focusing of a radiation beam focusing on the information layer through the transparent layer, the radiation beam arriving on the carrier via the entrance face based on the measured thickness variation.

13. The method of claim 12, further comprising:
determining the thickness variation of the transparent layer at another radius not indicated in the informative data by extrapolation or interpolation based on the thickness variation measured at the radius indicated in the informative data.
